(19) United States
(12) Patent Application Publication
(10) Pub. No.: US 2013/0115417 A1
(43) Pub. Date: May 9, 2013

(54) SOFT PAD AND MANUFACTURING METHOD THEREOF FOR VEHICLE

(71) Applicant: Byung Seok Kong, Gunpo-si (KR)

(72) Inventor: Byung Seok Kong, Gunpo-si (KR)

(73) Assignees: Kia Motors Corp., Seoul (KR); Hyundai Motor Company, Seoul (KR)

(21) Appl. No.: 13/559,248

(22) Filed: Jul. 26, 2012

(30) Foreign Application Priority Data
Nov. 3, 2011 (KR) 10-2011-0113744

(51) Int. Cl. B32B 3/10

(52) U.S. Cl. 428/138; 264/46.5

(57) ABSTRACT

A soft pad for a vehicle may include a soft foam layer stacked under a skin layer, a breathable film connected under the soft foam layer, to preserve thickness of the soft foam layer by protecting the soft foam layer from heat and pressure during a molding process and in which breathable holes may be formed to the breathable film at regular distances to let gas be released therethrough, and a pad resin injection-adhered under the breathable film.

### CROSS REFERENCE TO RELATED APPLICATION

The present application claims priority to Korean Patent Application No. 10-2011-0113744 filed on Nov. 3, 2011, the entire contents of which is incorporated herein for all purposes by this reference.

### BACKGROUND OF THE INVENTION

1. Field of the Invention

The present invention relates to a soft pad for vehicles and manufacturing method thereof for minimizing foam damage and maximizing the recovery rate in applying low density foams when manufacturing a soft foam and skin integrated crash pad through injection molding.

2. Description of Related Art

FIG. 1 is a view illustrating prior injection molding for a soft pad, FIG. 2 is a view illustrating a pressed phenomenon of soft foam of the soft pad in FIG. 1, and FIG. 3 is a cross sectional view illustrating the soft pad in FIG. 1.

When applying a soft foam to a pad such as a crash pad of a vehicle, or the like to improve handling feeling, there has been many cases that the soft foam is so weak to heat and pressure that its appearance are not good as it is pressed or it has wrinkles formed during a molding process.

Accordingly, soft foams are often excessively damaged when applying low density foams instead of an integrated foam for injection molding to improve handling feeling. As shown in FIG. 1, in manufacturing a soft pad, when shooting a pad resin 24 from a gate 22 on one mold 20 while placing with a skin 11 and a soft foam 12 on the other mold 10, a thickness of soft foam is often non-uniform as shown in FIG. 2 by compression of both molds 10, 20 in the process of molding. This phenomenon is also shown in FIG. 3, and thus there's a need of solving non-uniform in the thickness of the soft foam.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a soft pad for vehicles and manufacturing method thereof when applying low density foams, for minimizing foam damage, equalizing its thickness and maximizing its recovery rate.

In an aspect of the present invention, a soft pad for a vehicle may include a soft foam layer stacked under a skin layer, a breathable film connected under the soft foam layer, to preserve thickness of the soft foam layer by protecting the soft foam layer from heat and pressure during a molding process and in which breathable holes are formed to the breathable film at regular distances to let gas be released therethrough, and a pad resin injection-adhered under the breathable film.

The breathable film is so smoothly formed to let the pad resin pass therethrough.

The breathable film is made of TPO (Thermo Plastic Poly Olefin) which contains PP (Polypropylene).

The pad resin is injection-molded by being compressed after being shot under the breathable film through a plurality of mold gates formed to a mold.

The soft pad for a vehicle is a crash pad for a vehicle.

In another aspect of the present invention, a manufacturing method of a soft pad for a vehicle may include laminating in sequence under a first mold a skin layer, a soft foam layer and a breathable film which preserves the thickness of the soft foam layer by protecting the soft foam layer from heat and pressure during a molding process on one part of a second mold, shooting a pad resin toward the breathable film through a gate provided on the second mold, and compressing the pad resin by either or both of the first and second molds after being shot.

The breathable film is so smoothly formed to let the pad resin pass therethrough.

The breathable film is made of TPO (Thermo Plastic Poly Olefin) which contains PP (Polypropylene).

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating prior injection molding of a soft pad.

FIG. 2 is a view illustrating a pressed phenomenon of soft foams of the soft pad in FIG. 1.

FIG. 3 is a cross sectional view illustrating the soft pad in FIG. 1.

FIG. 4 is a view illustrating a soft pad according an exemplary embodiment of present invention.

FIG. 5 is a cross sectional view illustrating the soft pad in FIG. 4.

FIG. 6 is a view illustrating a rear surface of a breathable film of the soft pad in FIG. 4.

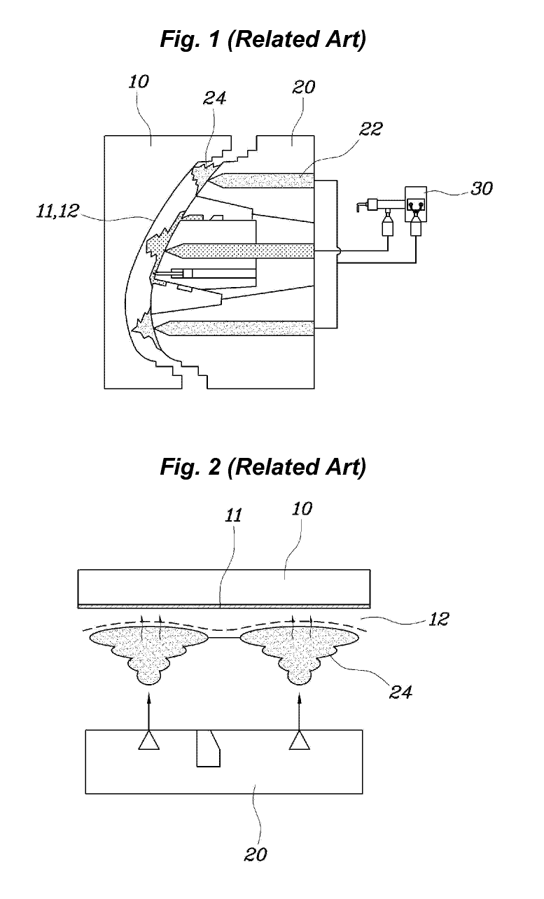

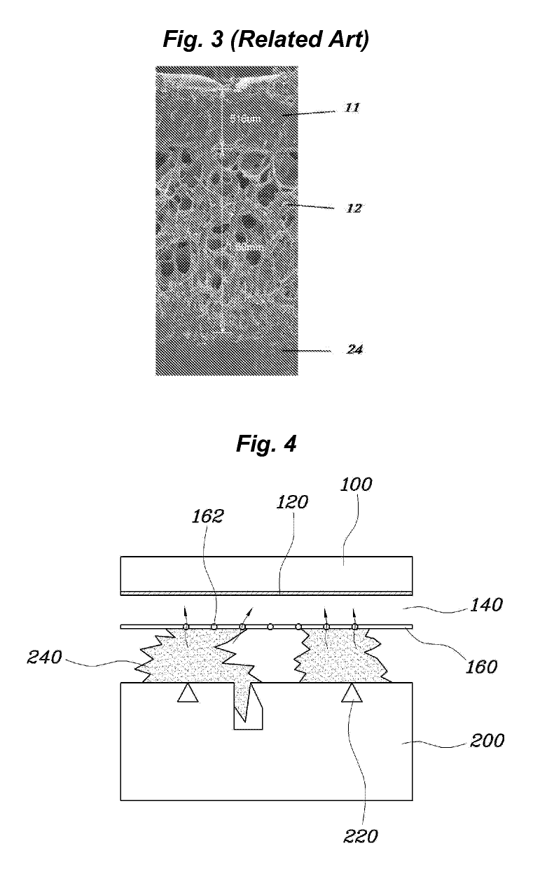

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

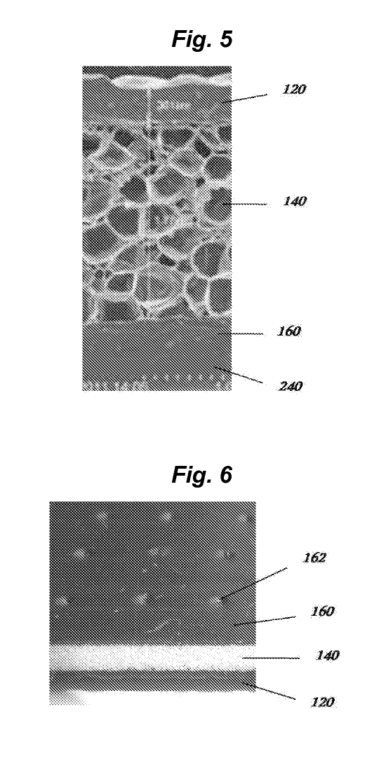

FIG. 4 is a view illustrating the soft pad according to an exemplary embodiment of the invention, FIG. 5 is a cross sectional view illustrating the soft pad in FIG. 4, and FIG. 6 is a view illustrating the rear surface of a breathable film of the soft pad in FIG. 4.

The soft pad according to an exemplary embodiment of the present invention includes an outermost skin layer 120, a soft foam layer 140 on a lower part of the skin layer 120, a breathable film 160 which is connected on a lower part of the soft foam layer 140 to preserve the thickness of the soft foam layer 140 by protecting it from heat and pressure during a molding process and to have breathable holes 162 foamed at regular distances to let gas be released, and a pad resin 240 connected through injection on a lower part of the breathable film 160.

That is, the skin layer 120, the soft foam layer 140 and the breathable film 160 are stacked in subsequent on one mold 100, the soft pad is injection molded by compressing the molds after the pad resin 240 is shot to the breathable film 160. At this time, the breathable film 160 shields the heat and pressure during the shooting of the pad resin, when applying the breathable film 160, and thereby solving the drawback of non-uniformed surface of soft foam 140.

Further, a breathable film 160 is provided with breathable holes 162, as shown in FIGS. 4 and 6, and thus the gas produced when melting the base material is transmitted through the soft foam 140 and absorbed therein, thereby avoiding the irregular surface or producing of wrinkles on a pad outer shape.

Meanwhile, a breathable film 160 are not to be deformed easily from heat and pressure since it is made of TPO (Thermo Plastic Poly Olefin) which contains High Melt Strength PP (Polypropylene).

Further, a breathable film 160, the surface of which are so smoothly formed to let the pad resin 240 pass through but not be accumulated on the surface so that pressure is not further applied to the soft foam 140.

Furthermore, a pad resin 240 is injection molded by being compressed after being shot on the lower part of the breathable film through a plurality of mold gates 220, and further the soft pad for a vehicle is suitable for a crash pad for a vehicle.

Meanwhile, a manufacturing method of the soft pad includes laminating the skin layer 120, the soft foam layer 140, and the breathable film 160 to preserve the thickness of the soft foam layer 140 by protecting the soft foam layer 140 from heat and pressure in the process of molding on one mold 100, shooting the pad resin 240 toward the breathable film 160 through the gate 220 provided on the other mold 200, and compressing the pad resin 240 after being shot.

Herein, the breathable film 160 may be made of TPO (Thermo Plastic Poly Olefin) which contains High Melt Strength PP (Polypropylene) and the surface of the breathable film 160 could be formed smoothly.

According to the soft pad for vehicles and manufacturing method thereof described above, it may minimize heat and pressure applied to the soft foam when integrally forming the soft foam by applying TPO material to a lower part of the soft foam.

Further, the gas produced during melting of base material in the integral molding process is avoided being absorbed and accumulated on the soft foam through the breathable holes of the breathable film.

Furthermore, by applying non embossed surface to the film surface, winkles which may be produced by shear force between the resin and the film when the resin is flown for molding the base material during the integrated molding process, can be avoided.

According to the soft pad for vehicles which has a structure above and the manufacturing method thereof, the soft foam is able to minimize transferred heat and pressure by applying the film of TPO material under the soft foam in the process of integrated molding.

In the process of integrated molding, the soft foam may avoid accumulation of gas absorbed in melting of raw material through the breathable hole of the film.

In a further embodiment, by applying non embossed surface to the film surface, the soft foam may avoid winkles being produced by shear force between the resin and the film during flowing of the resin for material molding in the process of integrated molding.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings.

The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A soft pad for a vehicle, comprising:
a soft foam layer stacked under a skin layer;
a breathable film connected under the soft foam layer, to preserve thickness of the soft foam layer by protecting the soft foam layer from heat and pressure during a molding process and in which breathable holes are formed to the breathable film at regular distances to let gas be released therethrough; and
a pad resin injection-adhered under the breathable film.

2. The soft pad for vehicle of claim 1, wherein the breathable film is so smoothly formed to let the pad resin pass therethrough.

3. The soft pad for vehicle of claim 1, wherein the breathable film is made of TPO (Thermo Plastic Poly Olefin) which contains PP (Polypropylene).

4. The soft pad for vehicle of claim 1, wherein the pad resin is injection-molded by being compressed after being shot under the breathable film through a plurality of mold gates formed to a mold.

5. The soft pad for vehicle of claim 1, wherein the soft pad for a vehicle is a crash pad for a vehicle.

6. A manufacturing method of a soft pad for a vehicle comprising:
laminating in sequence under a first mold a skin layer, a soft foam layer and a breathable film which preserves the thickness of the soft foam layer by protecting the soft foam layer from heat and pressure during a molding process on one part of a second mold;
shooting a pad resin toward the breathable film through a gate provided on the second mold; and
compressing the pad resin by either or both of the first and second molds after being shot.

7. The soft pad for vehicle of claim 6, wherein the breathable film is so smoothly formed to let the pad resin pass therethrough.

8. The manufacturing method of the soft pad for the vehicle of claim 6, wherein the breathable film is made of TPO (Thermo Plastic Poly Olefin) which contains PP (Polypropylene).
